(19) United States
(12) Patent Application Publication
(10) Pub. No.: US 2004/0114912 A1
(43) Pub. Date: Jun. 17, 2004

(54) Reproduction signal processing device

(75) Inventors: Kouji Okamoto, Osaka (JP); Akira Kawabe, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/678,080

(22) Filed: Oct. 6, 2003

(30) Foreign Application Priority Data
Dec. 16, 2002 (JP) 2002-363615

(51) Int. Cl. H04N 7/64; H04N 1/00; G11B 5/035

(52) U.S. Cl. 386/114; 360/65

(57) ABSTRACT

For the purpose of achieving reproduction of data recorded in an optical disc, or the like, with high accuracy and hence increasing the recording density, a digital filter is provided at a position between an A/D converter and an adaptive equalizing filter and between the A/D converter and a PLL circuit. Basically, an analog filter has only a low pass function. In a learning period prior to reproduction, a controller section sets various tap coefficients in the digital filter to determine a tap coefficient such that a jitter value detected in the PLL circuit is minimum. In a reproduction operation, the determined tap coefficient is set in the digital filter to perform optimum pre-equalization, and as a result, reproduction of data is performed with high accuracy.

### BACKGROUND OF THE INVENTION

The present invention relates to a reproduction signal processing device for reproducing data recorded in a recording medium, such as an optical disc, or the like, or data received from an external device.

In recent years, along with explosive propagation of the Internet, the amount of information to be processed, e.g., the amount of information handled by a single user, has been increasing. Accordingly, demands for a larger capacity storage device for storing a larger amount of information have been greatly increasing. For example, the capacity of a storage device can be increased by increasing the recording density. However, the influence of intersymbol interference increases along with the increase in the recording density, and the quality of a signal waveform to be reproduced readily deteriorates. Thus, it is difficult to greatly increase the recording density by increasing the resolution.

A known reproduction signal processing method which achieves high resolution and high reproduction performance is PRML (Partial Response Maximum Likelihood) method. A conventional reproduction signal processing device which achieves such a processing method has a structure shown in FIG. 24, for example.

The conventional reproduction signal processing device shown in FIG. 24 includes a pickup 901, a spindle motor 902, a variable gain amplifier (VGA) 904, a gain adjustment circuit 905, an analog filter 906, an adder circuit 907, an offset adjustment circuit 908, an A/D converter 909, a digital signal processing section 910, and a PLL (Phase Locked Loop) circuit 913.

The pickup 901 reads data recorded on a recording medium 903 spun by the spindle motor 902 and outputs a reproduction signal based on the data read from the recording medium 903.

The VGA 904 automatically adjusts the amplitude of the reproduction signal so as to adapt to the input dynamic range of the A/D converter 909. The VGA 904 is controlled by the gain adjustment circuit 905 based on an output of the A/D converter 909.

The analog filter 906 removes high band noise and performs pre-equalizing processing (for example, high band emphasis) according to PR equalization characteristics of the system (i.e., reproduction signal processing device).

The adder circuit 907 offsets the level of the reproduction signal under the control of the offset adjustment circuit 908 based on an output of the A/D converter 909 such that the average level of the reproduction signal is 0.

The A/D converter 909 quantizes the reproduction signal to output digital reproduction signal data.

The digital signal processing section 910 includes an adaptive equalizing filter 911 and a Viterbi detector 912. The digital signal processing section 910 extracts binary recorded data based on the reproduction signal data output from the A/D converter 909.

The PLL circuit 913 generates a clock signal which is in synchronization with the data extracted by the digital signal processing section 910 based on the reproduction signal data output from the A/D converter 909. The PLL circuit 913 outputs the clock to the A/D converter 909, the digital signal processing section 910, and an extracted data processing section (not shown).

Referring to FIG. 25, the adaptive equalizing filter 911 of the digital signal processing section 910 includes a filter section 921 and a tap coefficient control section 922.

The filter section 921 is formed by a FIR filter including a shift register 921a, multipliers 921b and an adder 921c.

The tap coefficient control section 922 controls tap coefficients which are to be input to the multipliers 921b. The tap coefficient control section 922 includes an expected value estimation section 922a, an adder 922b, and a tap coefficient update section 922c. In the tap coefficient control section 922, the tap coefficients are automatically updated (corrected) to optimum values such that an equalization error is decreased, whereby predetermined PR equalization corresponding to the characteristics of the Viterbi detector 912 is performed. For example, LMS (Least Mean Square) is employed as an algorithm of the tap coefficient correction.

In the reproduction signal processing device having the above structure, the analog filter 906 removes high band noise from an analog reproduction signal and performs pre-equalizing processing on the analog reproduction signal. A clock signal is generated by the PLL circuit 913 based on reproduction signal data obtained by A/D-converting the thus-processed reproduction signal. Based on such a clock signal, sampling by the A/D converter 909 and PR equalization by the adaptive equalizing filter 911 are appropriately performed. As a result, recorded data is reproduced with high accuracy, and accordingly, a higher recording density is realized relatively readily without increasing the error rate.

However, in the above method where pre-equalizing is performed by the analog filter 906, it is not easy to surely reproduce recorded data according to a variation in the characteristics of the reproduction signal, which is caused due to a deterioration of the recording medium 903 with passage of time or due to a variation in environmental conditions, because it is difficult to adjust the characteristics of the reproduction signal. For example, Japanese Unexamined Patent Publication No. 2001-184795 (paragraph 0018 and FIG. 21) discloses a known structure where an adaptive equalizer is provided between an A/D converter and a PLL circuit so as to increase the equalizing characteristics of reproduction signal data input to the PLL circuit.

In the above structure where the PLL circuit operates based on an output from the adaptive equalizer, parameters can be set readily as compared with adjustment of the analog filter 906. However, setting of the parameters is still complicated and difficult to establish. Moreover, recorded data are not surely reproduced in some cases. In our estimation, this is because the adaptive equalizer and the PLL circuit respectively form feedback loops, and these two feedback loops exist superposedly. Thus, these feedback loops interfere with each other and accordingly diverge.

### SUMMARY OF THE INVENTION

In view of the above problems, an objective of the present invention is to greatly increase the recording density by surely and readily performing reproduction of recorded data with high accuracy.

For the purpose of achieving the above objective, the first reproduction signal processing device of the present invention comprises: an A/D converter for quantizing an input analog reproduction signal into digital reproduction signal data; an adaptive equalizer for equalizing the reproduction signal data with a characteristic controlled according to data input to the adaptive equalizer and data output from the adaptive equalizer; and a PLL circuit for outputting a clock signal which is in synchronization with the reproduction signal data; an analog filter for removing noise from the reproduction signal; and a digital filter provided between the A/D converter and the adaptive equalizer, the digital filter equalizing the reproduction signal data with a fixed characteristic, wherein the PLL circuit outputs the clock signal based on an output of the digital filter.

The second reproduction signal processing device of the present invention is based on the first reproduction signal processing device, wherein the analog filter has a low pass characteristic.

The third reproduction signal processing device of the present invention is based on the first reproduction signal processing device, wherein the digital filter has a high band emphasis characteristic.

According to the above features, since the reproduction signal data equalized (pre-equalized) by the digital filter is input to the PLL circuit, the clock signal is in synchronization with the reproduction signal data with high accuracy, and appropriate sampling by the A/D converter and appropriate equalization by the adaptive equalizer are readily performed. Furthermore, since the characteristic of the digital filter is fixed, divergence of a feedback loop is readily suppressed. Thus, reproduction of recorded data is surely and readily performed with high accuracy.

The fourth reproduction signal processing device of the present invention is based on the third reproduction signal processing device, wherein the digital filter has a low pass characteristic which allows the passage of a lower frequency component as compared with the analog filter.

For example, the analog filter has a low pass characteristic which suppresses the influence of aliasing noise caused by A/D conversion, and the digital filter has a more stringent low pass characteristic. As a result, the reproduction signal processing device has an appropriate filter characteristic as a whole. On the other hand, the structure of the analog filter is simplified, whereby the chip area of a semiconductor integrated circuit including the reproduction signal processing device of the present invention is limited within a small area.

The fifth reproduction signal processing device of the present invention is based on the first reproduction signal processing device, wherein the digital filter is a FIR filter which has a characteristic determined according to one or more tap coefficients set in the digital filter.

With such a feature, the digital filter can readily be structured.

The sixth reproduction signal processing device of the present invention is based on the first reproduction signal processing device, wherein further comprising a control section for determining the fixed characteristic of the digital filter prior to the start of reproduction signal processing.

The seventh reproduction signal processing device of the present invention is based on the sixth reproduction signal processing device, wherein: the digital filter is a FIR filter which has a characteristic determined according to one or more tap coefficients set in the digital filter; and the control section sets any of a plurality of tap coefficient candidate values in the digital filter, thereby determining the fixed characteristic of the digital filter.

The eighth reproduction signal processing device of the present invention is based on the sixth reproduction signal processing device, wherein the control section determines the fixed characteristic of the digital filter based on a value corresponding to a phase error in the PLL circuit.

The ninth reproduction signal processing device of the present invention is based on the sixth reproduction signal processing device, wherein the control section determines the fixed characteristic of the digital filter based on an equalization error in the adaptive equalizer.

The tenth reproduction signal processing device of the present invention is based on the sixth reproduction signal processing device, wherein the control section determines the fixed characteristic of the digital filter based on a difference between data input to the adaptive equalizer and data output from the adaptive equalizer.

According to the above features, the characteristic of the digital filter is set such that the quality of the reproduction signal data is increased more surely. Thus, reproduction of recorded data is more surely and readily performed with high accuracy.

The eleventh reproduction signal processing device of the present invention is based on the sixth reproduction signal processing device, wherein prior to the start of reproduction signal processing, the control section synthesizes a predetermined characteristic with a characteristic converged by the operation of the adaptive equalizing filter and sets the synthesized characteristic as the fixed characteristic of the digital filter.

The twelfth reproduction signal processing device of the present invention is based on the sixth reproduction signal processing device, wherein each of the digital filter and the adaptive equalizer includes a FIR filter which has a characteristic determined according to one or more tap coefficients; and the control section sets, as the tap coefficient in the digital filter, a value obtained by the sum-of-products operation of the tap coefficient determined such that the digital filter has the predetermined characteristic and the tap coefficient determined such that the adaptive equalizer has the converged characteristic.

According to the above features, the function of correcting the group delay of the reproduction signal is provided to the digital filter in addition to the low pass function, high band emphasis function, and the like. Thus, reproduction signal data of high quality, for example, which is equivalent to the quality of a reproduction signal output from an adaptive equalizer of a conventional device not including a digital filter, is input to the PLL circuit. Therefore, a more accurate clock signal is obtained, and reproduction of recorded data is surely and readily performed with high accuracy.

The thirteenth reproduction signal processing device of the present invention is based on the first reproduction signal processing device, wherein the PLL circuit outputs a first clock signal for driving the adaptive equalizer and a second clock signal for driving the A/D converter and the digital filter, the second clock signal having a frequency that is N times higher than that of the first clock signal where N is an integer equal to or greater than 2.

A so-called oversampling is performed in such a way, whereby A/D conversion and equalization by the digital filter are readily performed with high accuracy.

The fourteenth reproduction signal processing device of the present invention is based on the first reproduction signal processing device, wherein: the reproduction signal processing device reads recorded data from a recording medium; the analog filter has a low pass characteristic; and the upper limit of a frequency component which is allowed to pass through the analog filter is changed according to the speed of reading the recorded data.

With such a feature, the influence of aliasing noise is readily eliminated according to the speed of reading recorded data.

The fifteenth reproduction signal processing device of the present invention is based on the first reproduction signal processing device, wherein: the reproduction signal processing device reads recorded data from a recording medium; the PLL circuit outputs a first clock signal for driving the adaptive equalizer and a second clock signal for driving the A/D converter and the digital filter; the frequency of the first clock signal is determined according to the speed of reading the recorded data; and the frequency of the second clock signal is substantially constant irrespective of the speed of reading the recorded data.

The sampling frequency of the A/D converter is kept constant in this way, whereby the influence of aliasing noise is readily eliminated for different speeds of reading recorded data without varying the characteristic of the analog filter.

### BRIEF DESCRIPTION OF THE DRAWINGS

FIG. 1 is a block diagram showing the principal part of a reproduction signal processing device according to embodiment 1.

FIG. 2 is a block diagram showing the structure of a digital filter 107 according to embodiment 1.

FIG. 3 is a block diagram showing the structure of an adaptive equalizing filter 109 according to embodiment 1.

FIG. 4 is a block diagram showing the structure of a controller section 112 according to embodiment 1.

FIG. 5 illustrates contents stored in a tap coefficient table 131 according to embodiment 1.

FIG. 6 is a block diagram showing the structure of a PLL circuit 111 according to embodiment 1.

FIG. 7 illustrates an example of phase error detection according to embodiment 1.

FIG. 8 is a block diagram showing the principal part of a reproduction signal processing device according to embodiment 2.

FIG. 9 is a block diagram showing the structure of an adaptive equalizing filter 209 according to embodiment 2.

FIG. 10 is a block diagram showing the principal part of a reproduction signal processing device according to embodiment 3.

FIG. 11 is a block diagram showing the principal part of a reproduction signal processing device according to embodiment 4.

FIG. 12 is a block diagram showing the structure of a controller section 412 according to embodiment 4.

FIG. 13 illustrates an example of synthesis of tap coefficients according to embodiment 4.

FIG. 14 illustrates an alternative example of synthesis of tap coefficients according to embodiment 4.

FIG. 15 illustrates a still alternative example of synthesis of tap coefficients according to embodiment 4.

FIG. 16 is a block diagram showing the principal part of a reproduction signal processing device of variation 1.

FIG. 17 is a block diagram showing the principal part of a PLL circuit 511 of variation 1.

FIG. 18 illustrates an example of an oversampling operation according to variation 1.

FIG. 19 is a block diagram showing the principal part of a reproduction signal processing device of variation 2.

FIG. 20 is a graph showing examples of the characteristics of an analog filter 603.

FIG. 21 is a block diagram showing the principal part of a reproduction signal processing device according to embodiment 5.

FIG. 22 is a graph showing examples of the characteristics of an analog filter 103 and a digital filter 107 in the double-speed reproduction mode according to embodiment 5.

FIG. 23 is a graph showing examples of the characteristics of the analog filter 103 and the digital filter 107 in the single-speed reproduction mode according to embodiment 5.

FIG. 24 is a block diagram showing the principal part of a conventional reproduction signal processing device.

FIG. 25 is a block diagram showing the structure of an adaptive equalizing filter 911 of the conventional reproduction signal processing device.

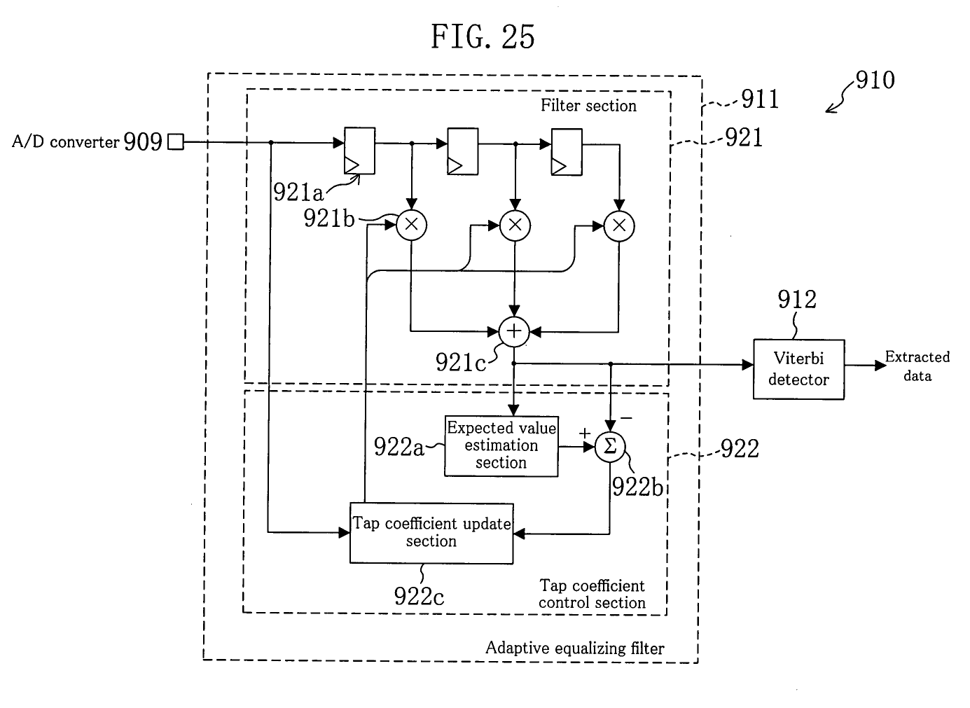

### DESCRIPTION OF THE PREFERRED EMBODIMENTS

Hereinafter, embodiments of the present invention are described with reference to the drawings while illustrating a reproduction signal processing device for reproducing data recorded in a removable recording medium, such as a DVD (Digital Versatile Disc), or the like.

(Embodiment 1)—

Structure of Reproduction Signal Processing Device

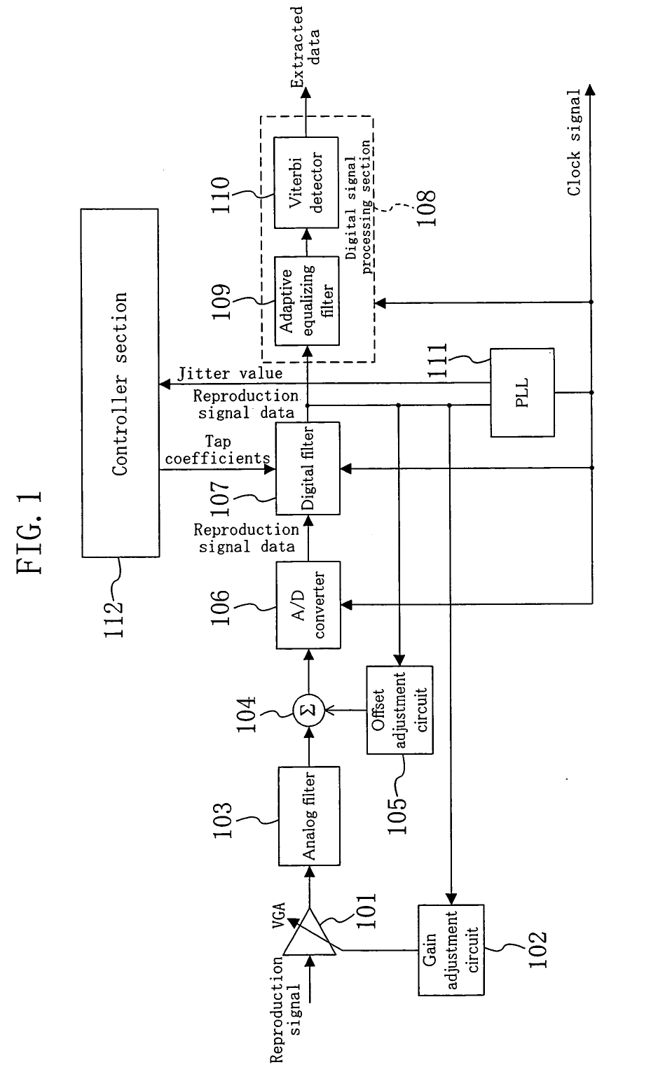

FIG. 1 is a block diagram showing the principal part of a reproduction signal processing device according to embodiment 1.

Referring to FIG. 1, the reproduction signal processing device of embodiment 1 includes a variable gain amplifier (VGA) 101, a gain adjustment circuit 102, an analog filter 103, an adder circuit 104, an offset adjustment circuit 105, an A/D converter 106, a digital filter 107, a digital signal processing section 108, a PLL (Phase Locked Loop) circuit 111 and a controller section 112.

The VGA 101 receives a reproduction signal from a pickup (not shown) which reads data recorded in a recording medium, e.g., an optical disc, and automatically adjusts the amplitude of the reproduction signal so as to adapt to the input dynamic range of the A/D converter 106. The VGA 101 is controlled by the gain adjustment circuit 102 based on an output of the A/D converter 106.

The analog filter 103 is formed by a low pass filter which removes high band noise from the reproduction signal.

The adder circuit 104 offsets the level of the reproduction signal such that the average level of the reproduction signal is 0. The adder circuit 104 is controlled by the offset adjustment circuit 105 based on an output of the A/D converter 106.

The A/D converter 106 quantizes the reproduction signal to output digital reproduction signal data.

The digital filter 107 removes high band noise with a cutoff frequency lower than that of the analog filter 103. The characteristics of the digital filter 107 are controlled by the controller section 112. Moreover, the digital filter 107 performs pre-equalizing processing (e.g., high band emphasis) according to the PR equalization characteristics of the system (i.e., reproduction signal processing device)

The digital signal processing section 108 includes an adaptive equalizing filter 109 and a Viterbi detector 110. The digital signal processing section 108 extracts binary recorded data from the reproduction signal data output from the digital filter 107.

The controller section 112 controls the characteristics of the digital filter 107 according to a jitter value output from the PLL circuit 111. For example, during a preliminary reproduction operation (learning period) which may be performed, for example, when a recording medium is placed in the reproduction apparatus, tap coefficients are determined such that the jitter value output from the PLL circuit 111 is minimum. Thereafter, in a normal reproduction operation, the determined tap coefficients are output to the digital filter 107.

The PLL circuit 111 generates a clock signal which is in synchronization with the data extracted by the digital signal processing section 108 based on the reproduction signal data output from the digital filter 107, and outputs the generated clock to the A/D converter 106, the digital filter 107, the digital signal processing section 108, and an extracted data processing section (not shown).

Hereinafter, the digital filter 107, the adaptive equalizing filter 109, the controller section 112 and the PLL circuit 111 are described in more detail.

(Digital Filter 107)

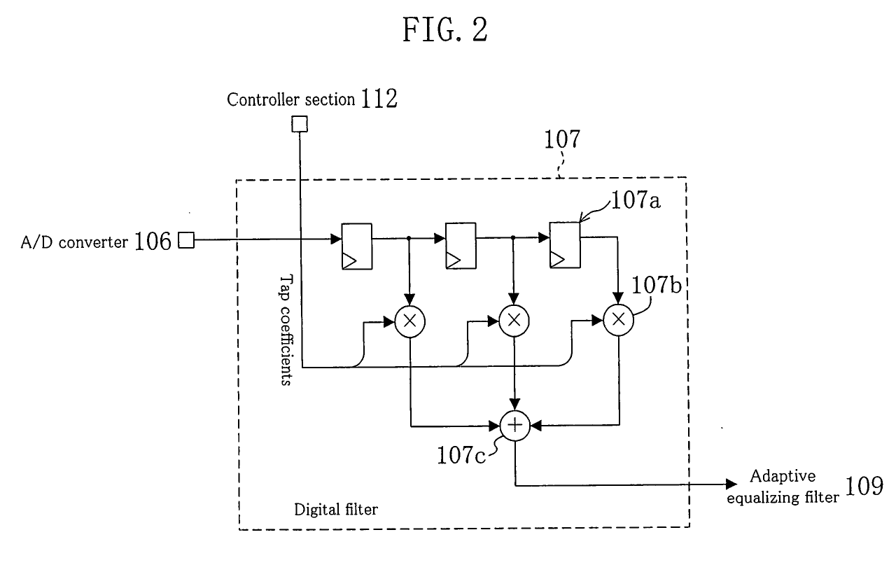

The digital filter 107 is formed by, for example, a transversal FIR filter including a shift register 107a, multipliers 107b and an adder 107c as shown in FIG. 2. The filter characteristics of the digital filter 107 are controlled according to tap coefficients input from the controller section 112 to the multipliers 107b.

(Adaptive Equalizing Filter 109)

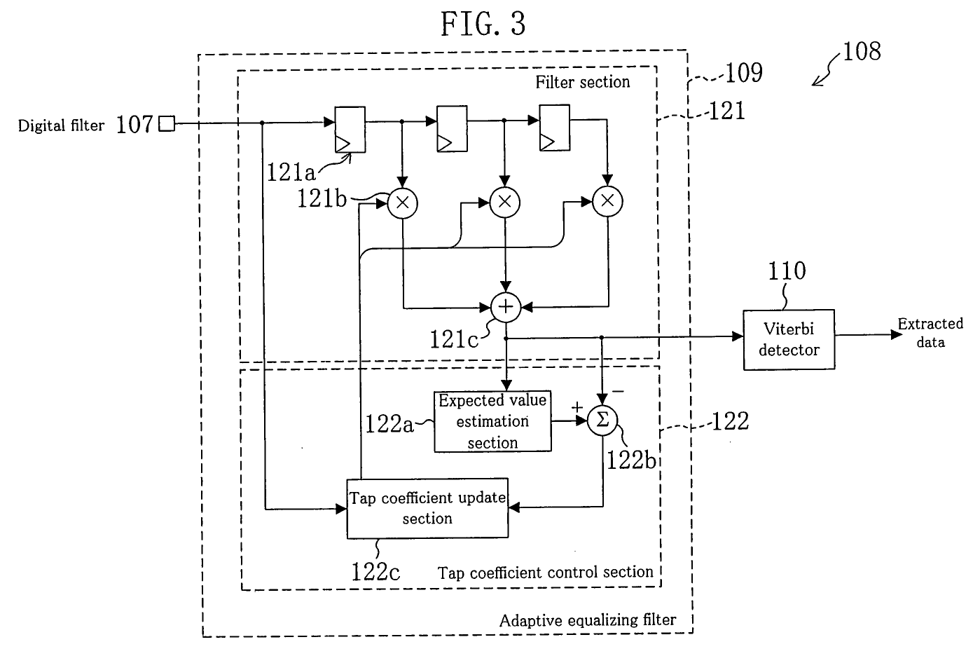

The adaptive equalizing filter 109 of the digital signal processing section 108 includes, for example, a filter section 121 and a tap coefficient control section 122 as shown in FIG. 3.

For example, the filter section 121 is formed by a FIR filter including a shift register 121a, multipliers 121b and an adder 121c.

The tap coefficient control section 122 controls the tap coefficients input to the multipliers 121b. The tap coefficient control section 122 includes an expected value estimation section 122a, a subtracter 122b and a tap coefficient update section 122c. The expected value estimation section 122a outputs an expected value that is estimated according to the reproduction signal data from the filter section 121 as a correct value of the reproduction signal data. The subtracter 122b calculates a difference between the expected value and the output of the filter section 121 (equalization error). The tap coefficient update section 122c updates (corrects) tap coefficients which are to be output to the multipliers 121b of the filter section 121 according to the relationship between the equalization error and the reproduction signal data input to the filter section 121. For example, LMS (Least Mean Square) is employed as an algorithm of the tap coefficient correction. In the above structure, the tap coefficients are automatically updated to optimum values such that the equalization error is decreased, and thus, predetermined PR equalization suitable to the characteristics of the Viterbi detector 110 (for example, PR (1,1) equalization, PR (1,2,1) equalization, or the like) is performed.

(Controller Section 112)

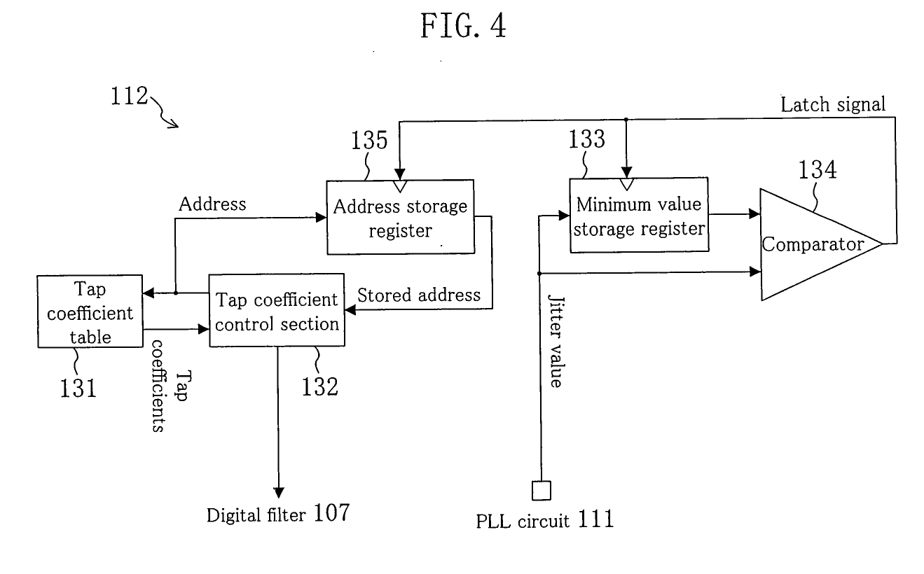

The controller section 112 includes, for example, a tap coefficient table 131, a tap coefficient control section 132, a minimum value storage register 133, a comparator 134 and an address storage register 135 as shown in FIG. 4.

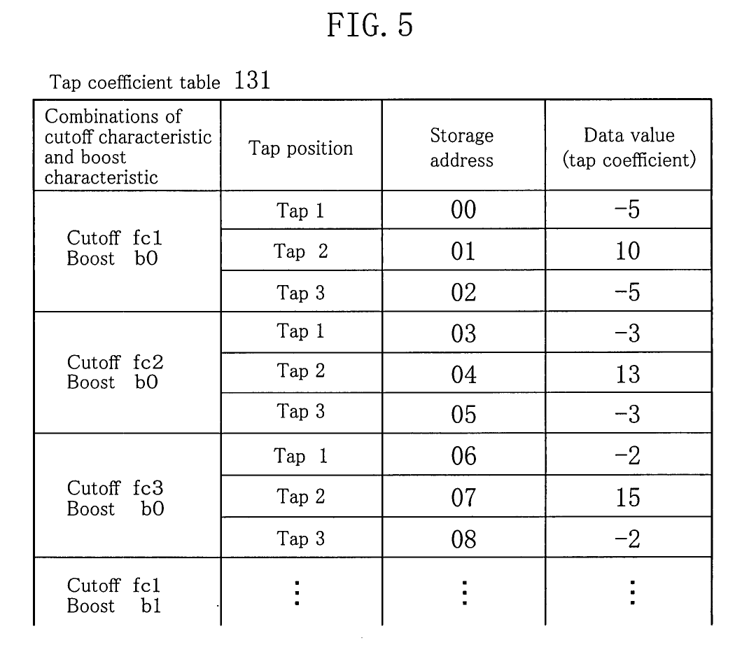

For example, as shown in FIG. 5, the tap coefficient table 131 stores a plurality of sets of tap coefficients corresponding to various combinations of the cutoff characteristic and high band emphasis characteristic (i.e., boost characteristic). The tap coefficients are stored in respective storage address regions.

During a learning period which may occur, for example, when a recording medium is placed in the reproduction apparatus, the tap coefficient control section 132 sequentially reads the sets of tap coefficients stored in the tap coefficient table 131 and outputs the read tap coefficients to the digital filter 107. On the other hand, in a normal reproduction operation which is performed after the leaning period, the tap coefficient control section 132 reads a set of tap coefficients corresponding to an address stored in the address storage register 135 and outputs the read tap coefficients to the digital filter 107.

The minimum value storage register 133 stores the minimum value of the jitter value output from the PLL circuit 111 according to the tap coefficients output from the tap coefficient control section 132.

The comparator 134 compares the value stored in the minimum value storage register 133 with the jitter value output from the PLL circuit 111. If the jitter value output from the PLL circuit 111 is smaller than the minimum value, the comparator 134 outputs a latch signal (latch pulse), and the jitter value is stored in the minimum value storage register 133 as a new minimum value.

The address storage register 135 stores, according to the latch signal output from the comparator 134, an address output from the tap coefficient control section 132, i.e., an address of a region in the tap coefficient table 131 in which a set of tap coefficients corresponding to the minimum jitter value are stored.

The controller section 112 is not limited to a hardware structure as described above. Alternatively, the function of the controller section 112 may be realized by a microcomputer and software installed therein.

(PLL Circuit 111)

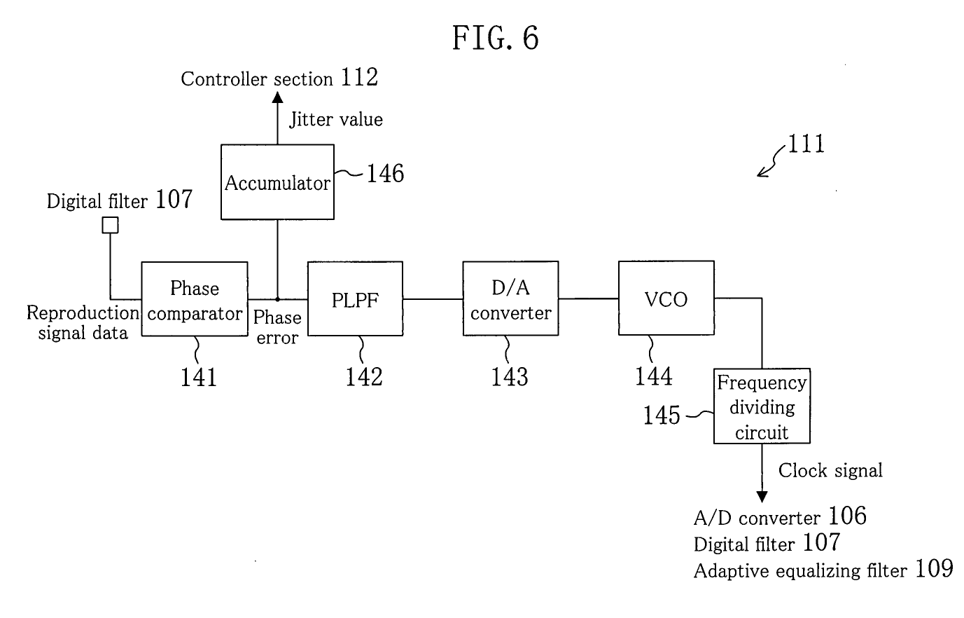

The PLL circuit 111 includes, for example, a phase comparator 141, a PLPF (Phase Loop Filter) 142, a D/A converter 143, a VCO (Voltage-Controlled Oscillator) 144, and a frequency dividing circuit 145 and an accumulator 146 as shown in FIG. 6. The accumulator 146 accumulates the absolute values (or squared values) of phase errors output from the phase comparator 141 and outputs the average value of the accumulation result as the jitter value to the controller section 112. In general, outputting the average value of the phase error to the controller section 112 as described above is preferable in view of the advantage of readily decreasing the influence of a variation in the phase error. However, the present invention is not limited to such an arrangement. The PLL circuit 111 may output a value corresponding to the phase error. For example, the PLL circuit 111 may output the phase error as it is. Alternatively, the PLL circuit 111 may output the phase error as it is, and the average value of the phase error may be calculated by the controller section 112. Still alternatively, if a variation (standard deviation) in the phase error is equal to or greater than a predetermined value, determination of the minimum value in the controller section 112 may not be performed (even when the average value of the phase error is small). Furthermore, although the frequency dividing circuit 145 may be omitted, the influence of fluctuations in the frequency is reduced more readily in a structure where the VCO 144 outputs a high frequency clock and the frequency dividing circuit 145 divides the frequency of the clock.

Operation of Reproduction Signal Processing Device

In the reproduction signal processing device having the above structure, a learning period occurs prior to reproduction of data recorded in the recording medium, for example, when a recording medium is placed in the reproduction signal processing device. In the learning period, a preliminary reproduction operation is carried out as described below in order to determine the tap coefficients given to the digital filter 107.

The tap coefficient control section 132 of the controller section 112 (FIG. 4) sequentially reads the (sets of) tap coefficients stored in the tap coefficient table 131 and outputs the tap coefficients to the digital filter 107. On the other hand, the other components operate as in the normal reproduction operation. A reproduction signal output from an optical pickup, or the like, is subjected to a gain adjustment by the VGA 101, removal of high band noise by the analog filter 103, and an offset adjustment by the adder circuit 104. The A/D converter 106 performs sampling of an analog reproduction signal output from the adder circuit 104 based on a clock signal output from the PLL circuit 111 to convert the signal to digital reproduction data, and outputs the digital reproduction data to the digital filter 107. The digital filter 107 performs pre-equalization on the reproduction signal data with the cutoff characteristic and boost characteristic which are determined by the tap coefficients output from the controller section 112.

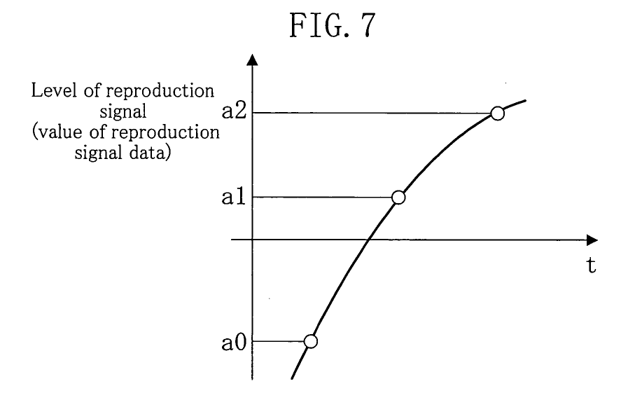

The pre-equalized reproduction signal data is input to the PLL circuit 111 (FIG. 6). The phase comparator 141 detects a phase error between the pre-equalized reproduction signal data and a clock signal output from the frequency dividing circuit 145. This detection is performed based on, for example, values at sampling timings in the vicinity of a zero cross point in the reproduction signal data. More specifically, referring to FIG. 7, the difference (phase error) between the timing of the actual zero cross point in the reproduction signal and the sampling timing of value a1 is obtained calculating the value of the expression: a1/(a0−a2), where a0, a1 and a2 denote values of the reproduction signal data which are sampled in the vicinity of the zero cross point. The oscillation frequency of the VCO 144 is controlled according to the phase error, whereby the phase of the clock signal is controlled so as to be in synchronization with the zero cross points of the reproduction signal. Moreover, the absolute value of the phase error is averaged by the accumulator 146 to obtain a jitter value, and the jitter value is input to the controller section 112.

In the controller section 112 (FIG. 4), every time a jitter value smaller than the value stored in the minimum value storage register 133 is input from the PLL circuit 111, the jitter value is stored in the minimum value storage register 133 as the minimum value. An address corresponding to the tap coefficients output to the digital filter 107 at this time (an address of a region in the tap coefficient table 131 in which the tap coefficients are stored) is stored in the address storage register 135.

The above operation is performed for each of the sets of tap coefficients stored in the tap coefficient table 131, thereby determining the set of tap coefficient which renders the jitter value minimum. The minimum jitter value means that pre-equalization by the digital filter 107 is appropriately performed, and that the timing of the zero cross point in the reproduction signal data output from the digital filter 107 is stable. Furthermore, the PLL operation is performed based on such a reproduction signal data, whereby a reproduction signal data sampled at an appropriate timing by the A/D converter 106 is obtained.

Thus, in the subsequent normal reproduction operation, the above-described tap coefficients are given to the digital filter 107, whereby reproduction signal data which has undergone the sampling and pre-equalization at an appropriate timing is input to the adaptive equalizing filter 109. Therefore, PR equalization by the adaptive equalizing filter 109 is appropriately performed, and reproduction of recorded data by the Viterbi detector 110 is performed.

As described above, the tap coefficients of the digital filter 107 are determined using the jitter value as an index. Thus, appropriate tap coefficients are readily obtained according to variations in the recording medium and environmental conditions, and such tap coefficients are fixedly set in the digital filter 107. As a result, pre-equalization and the PLL operation are performed without bringing the feedback loops into unstable states, and reproduction of recorded data is performed with high accuracy.

A filter whose gain changes relatively moderately according to the frequency and which has the least low pass characteristic necessary for suppressing aliasing noise is used as the analog filter 103, and the characteristics of the digital filter 107 are determined so as to achieve optimum filter characteristics when combined with the characteristics of the analog filter 103. Thus, the state where the PLL is unlikely to be locked due to the group delay which may be caused when the analog filter 103 has a steep cutoff characteristic is avoided, and the analog filter 103 is free from the constraints of the limit of the high band boost. Therefore, it is not necessary to improve the functions and performance of the analog filter 103, although such an improvement may be difficult when the size of a semiconductor integrated circuit is decreased. Accordingly, the structure of the analog filter 103 can readily be simplified, and the chip area of the semiconductor integrated circuit can readily be reduced.

(Embodiment 2)

A reproduction signal processing device of embodiment 2 is now described. In embodiment 2, components having the same functions are denoted by the same reference numerals used in embodiment 1, and descriptions thereof are herein omitted.

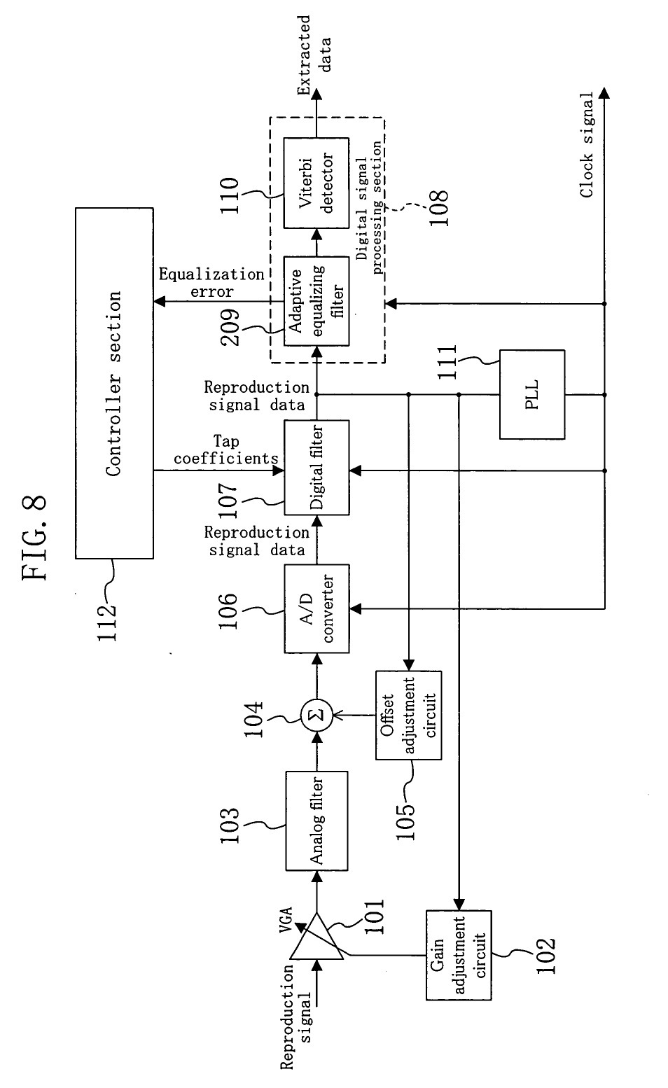

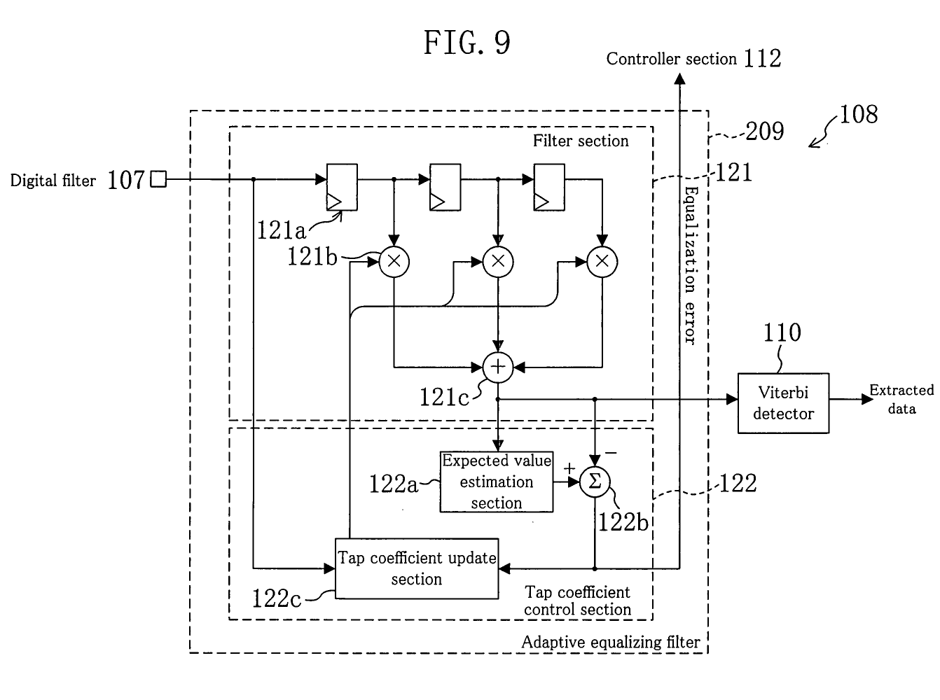

Referring to FIG. 8, the reproduction signal processing device of embodiment 2 includes an adaptive equalizing filter 209 in place of the adaptive equalizing filter 109 (FIG. 3) of the reproduction signal processing device of embodiment 1 (FIG. 1). The adaptive equalizing filter 209 outputs an equalization error to the controller section 112. Specifically, the equalization error is a difference between the output of the filter section 121 and the output of the expected value estimation section 122a of the adaptive equalizing filter 209 shown in FIG. 9.

The operation of the controller section 112 which is carried out based on the equalization error is basically the same as that described in embodiment 1. That is, in the learning period, various tap coefficients are set in the digital filter 107 and optimum tap coefficients are determined such that the equalization error is minimum. The minimum equalization error means that pre-equalization (similar to PR equalization) is substantially surely performed on a steady distortion in a waveform by the digital filter 107 while the adaptive equalizing filter 209 performs equalization processing mainly according to a dynamic variation, or the like. Thus, the equalization error in the adaptive equalizing filter 209 is used as an index for obtaining the optimum tap coefficients for the digital filter 107 as described above, whereby pre-equalization and the PLL operation are appropriately performed, and reproduction of recorded data is performed with high accuracy.

(Embodiment 3)

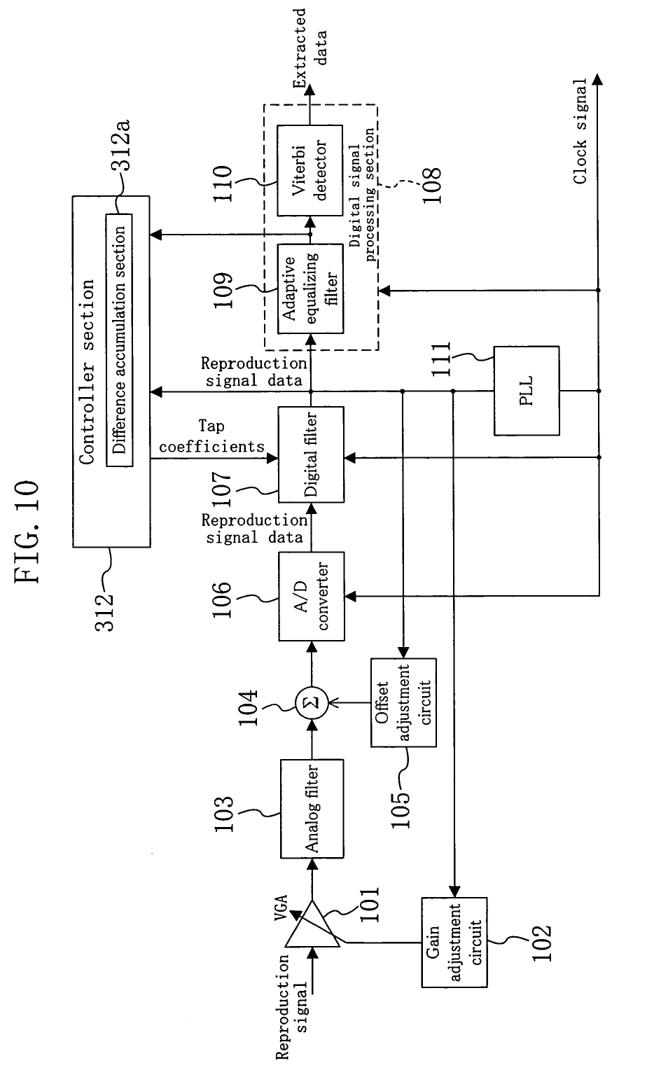

In a reproduction signal processing device of embodiment 3 shown in FIG. 10, reproduction signal data input from the digital filter 107 to the adaptive equalizing filter 109 and reproduction signal data output from the adaptive equalizing filter 109 are input to a controller section 312. The controller section 312 includes a difference accumulation section 312a in addition to the components of the controller section 112 of embodiment 1 (FIG. 4). The difference accumulation section 312a calculates the average value of the absolute value (or squared value) of the difference between the reproduction signal data input to the adaptive equalizing filter 109 and the reproduction signal data output from the adaptive equalizing filter 109. In the operation of the controller section 312, the tap coefficients are determined such that the average value output from the difference accumulation section 312a is minimum in a similar manner to that of the controller section 112 of embodiment 1.

As described above, the tap coefficients of the digital filter 107 are determined such that the difference between the reproduction signal data input to the adaptive equalizing filter 109 and the reproduction signal data output from the adaptive equalizing filter 109 is minimum, whereby pre-equalization by the digital filter 107 is appropriately performed, and therefore, reproduction of recorded data is performed with high accuracy.

Alternatively to the above arrangement where the tap coefficients are determined such that the difference between the reproduction signal data input to the adaptive equalizing filter 109 and the reproduction signal data output from the adaptive equalizing filter 109 is minimum, the tap coefficients may be determined such that the above difference is most frequently equal to or smaller than, or least frequently equal to or greater than, a predetermined reference value.

(Embodiment 4)

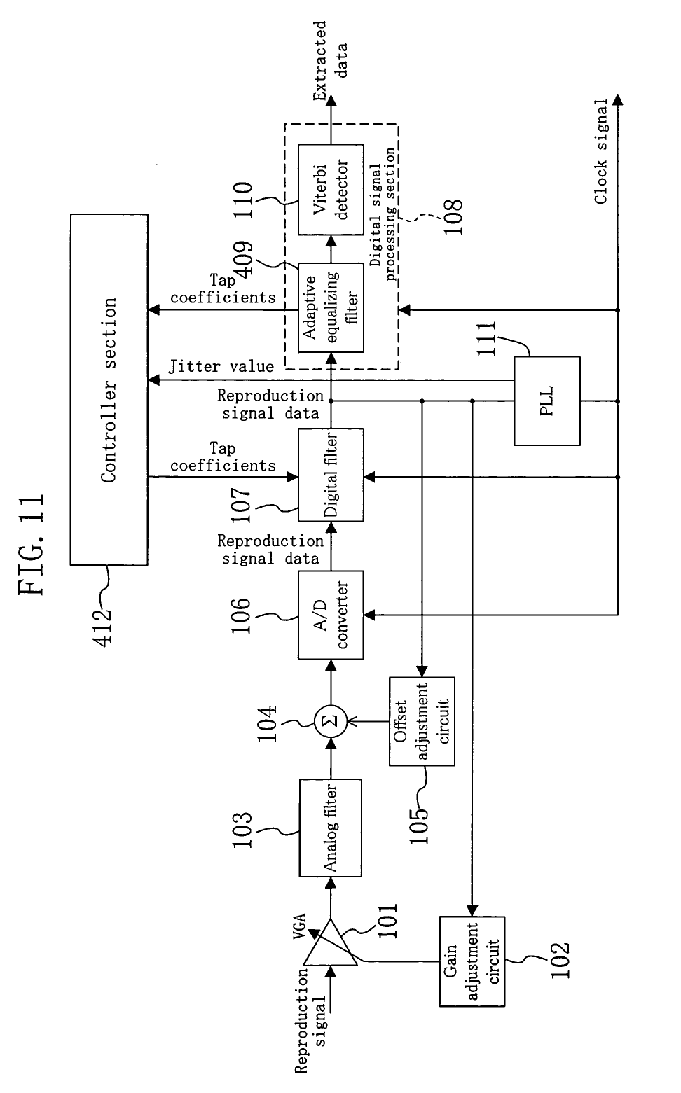

The reproduction signal processing device of embodiment 4 shown in FIG. 11 is different from the reproduction signal processing device of embodiment 1 (FIG. 1) in that the reproduction signal processing device of embodiment 4 includes an adaptive equalizing filter 409 and a controller section 412 in place of the adaptive equalizing filter 109 and the controller section 112.

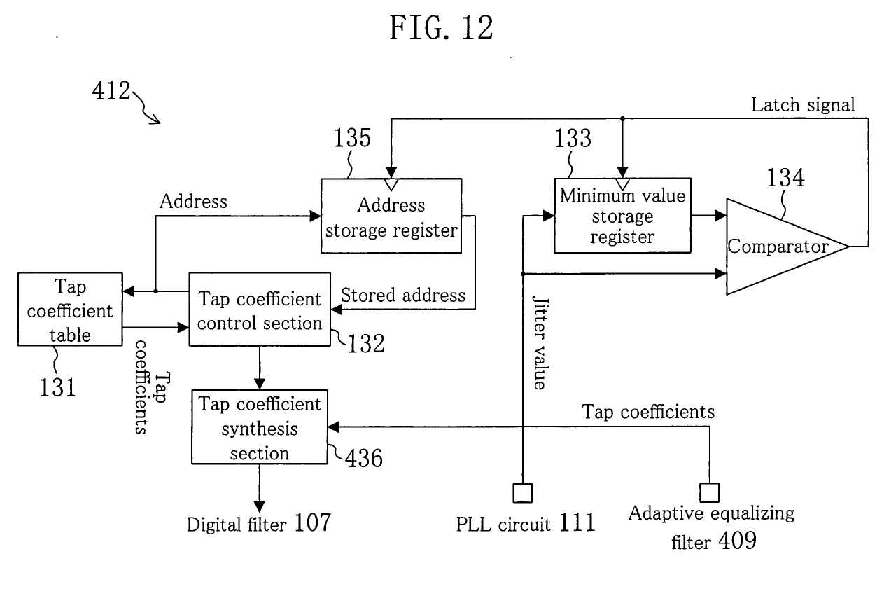

The adaptive equalizing filter 409 outputs tap coefficients used at the end of the learning period, i.e., tap coefficients converged such that appropriate PR equalization is performed, to the controller section 412. Referring to FIG. 12, the controller section 412 includes a tap coefficient synthesis section 436 in addition to the components of the controller section 112. In the tap coefficient synthesis section 436, the tap coefficients output from the adaptive equalizing filter 409 and the tap coefficients obtained in the same manner as in embodiment 1 are brought into a synthesis (convolution) to obtain synthesized tap coefficients. The tap coefficient synthesis section 436 sets the synthesized tap coefficients in the digital filter 107 in the normal reproduction operation.

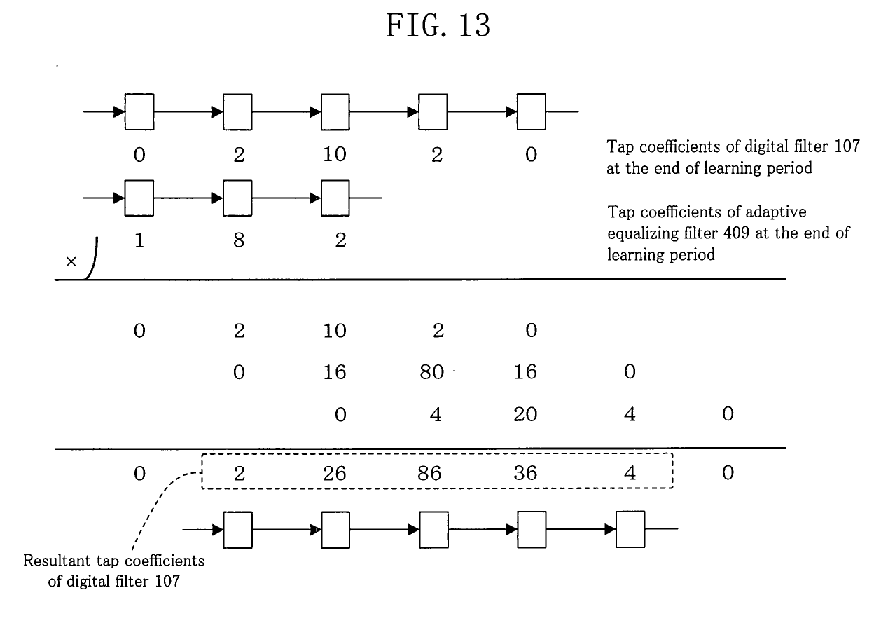

Now, the convolution operation in the tap coefficient synthesis section 436 is described more specifically. It is herein assumed that the number of taps of the digital filter 107 is 5 and the number of taps of the adaptive equalizing filter 409 is 3. Among the five taps of the digital filter 107, only central three taps, i.e., only the center tap and its neighboring taps, are used in the learning period (for example, the tap coefficients of the taps at the both ends are 0), and the tap coefficients of the central three taps are determined such that the jitter value detected by the PLL circuit 111 is minimum as described in embodiment 1. In the adaptive equalizing filter 409, the tap coefficients, which correspond to the tap coefficients of the digital filter 107, are determined such that PR equalization is optimized. Then, the tap coefficient synthesis section 436 of the controller section 412 synthesizes the above two sets of tap coefficients and sets the obtained tap coefficients in the digital filter 107. Now, consider a specific case where at the end of the learning period, the tap coefficients of the digital filter 107 are (0, 2, 10, 2, 0) and the tap coefficients of the adaptive equalizing filter 409 are (1, 8, 2) as shown in FIG. 13. The sum of products of the above tap coefficients is synthesized tap coefficients (2, 26, 86, 36, 4) which are set in the digital filter 107. The arithmetic operation illustrated in FIG. 13 is basically the same as a common multiplication of a 5-digit number and a 3-digit number, except that the multiplication proceeds from the leftmost place in FIG. 13.

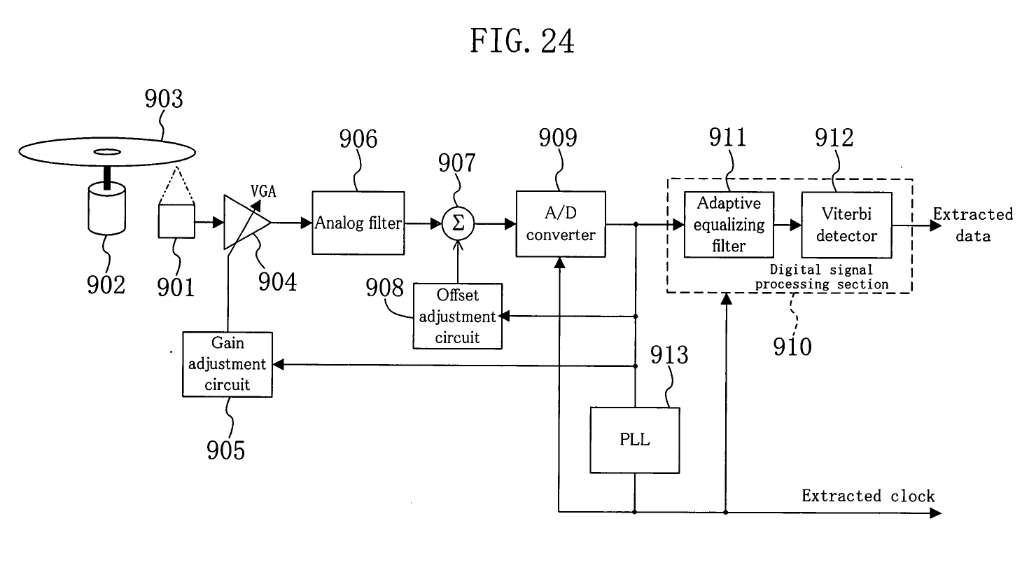

The above synthesized tap coefficients are set in the digital filter 107, whereby the digital filter 107 has the function of correcting the group delay in the reproduction signal in addition to the low pass function and the high band emphasis function. Thus, as compared with the conventional structure of FIG. 24, the reproduction signal data input to the PLL circuit 111 has high quality equivalent to that of the reproduction signal output from the adaptive equalizing filter 911. Therefore, a more accurate clock signal is obtained. Furthermore, since the above pre-equalization is performed with the tap coefficients set to fixed values, there is no possibility that the influence of the feedback control by the adaptive equalizing filter is reflected in the PLL circuit so that the operation of the PLL circuit becomes unstable as in Japanese Unexamined Patent Publication No. 2001-184795.

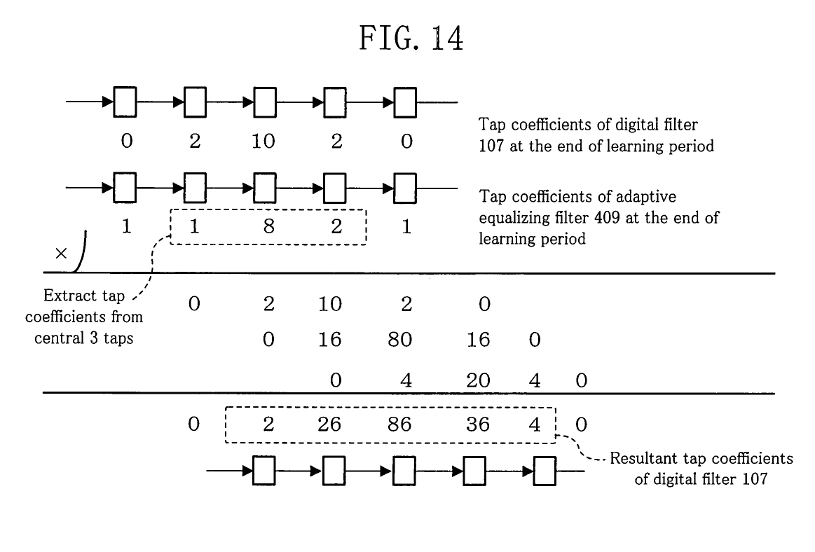

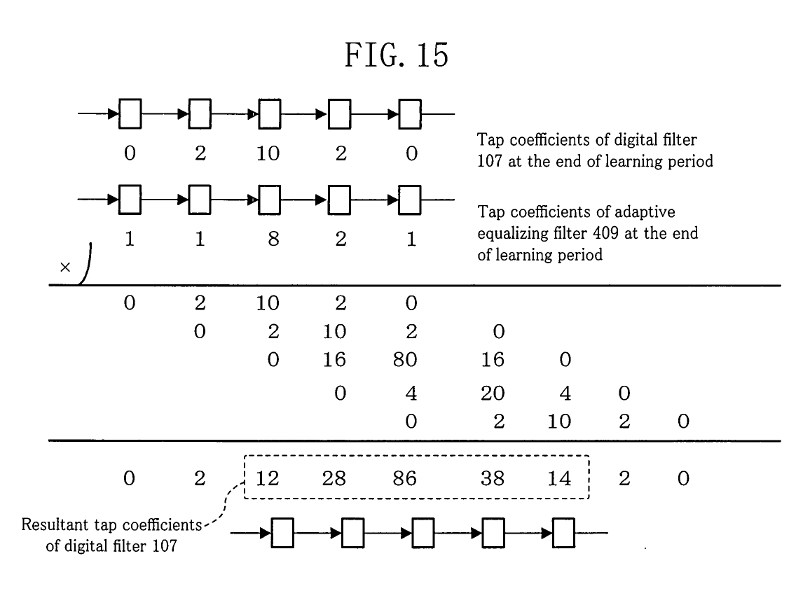

The number of taps in the digital filter 107, or the like, and the method of synthetic operation in the tap coefficient synthesis section 436 are merely examples provided for convenience of explanation, but the present invention is not limited thereto. For example, even when that the number of taps of the adaptive equalizing filter 409 is also 5, the sum-of-products operation may be performed only on the central three taps which largely affect the filter characteristic as shown in FIG. 14. Alternatively, the sum-of-products operation may be performed on all of the five tap coefficients, and the tap coefficients of central five taps in the operation result, which largely affect the filter characteristic, may be used, as shown in FIG. 15. Furthermore, also as for the digital filter 107, assuming that effective tap coefficients are set in all of the taps of the digital filter 107, only the tap coefficients of the central taps may be used in the sum-of-products operation, or only some tap coefficients in the operation result may be set in the digital filter 107.

(Variation 1)

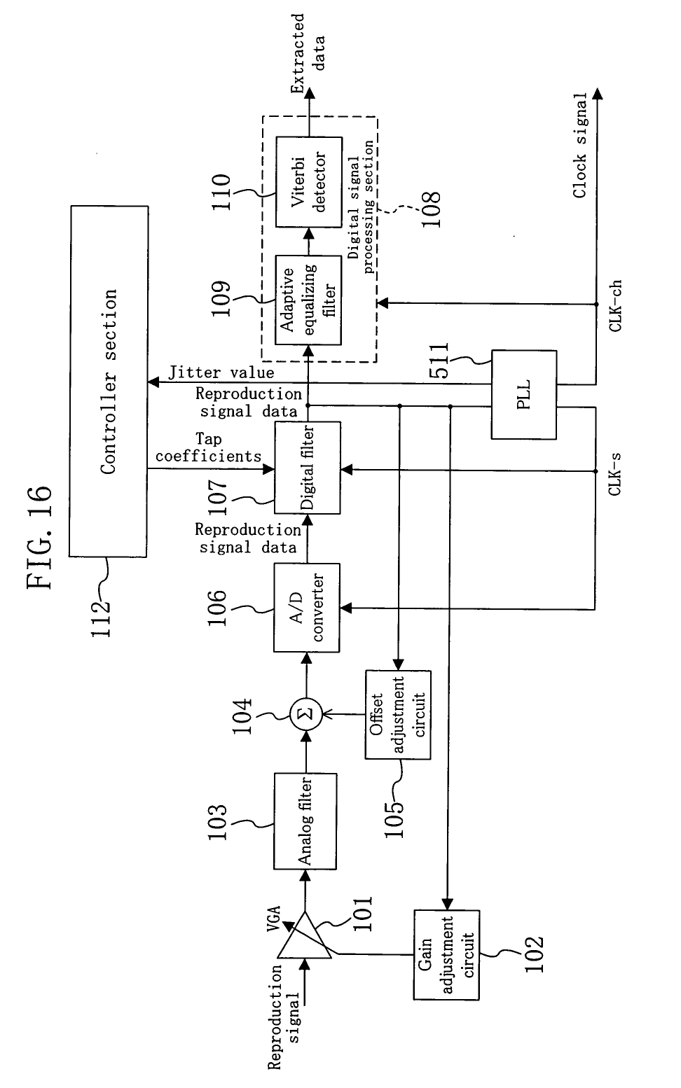

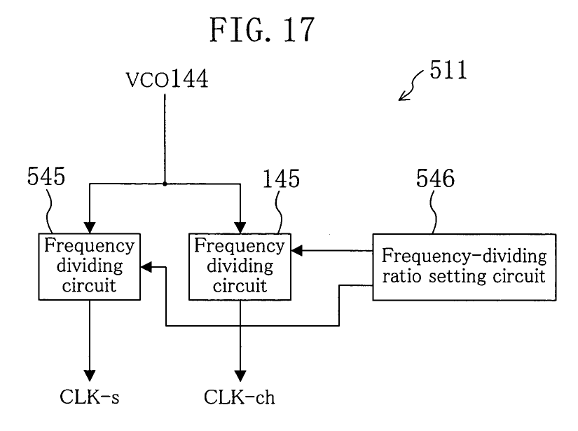

Although in the above example the same clock signal (i.e., clock signals having the same frequency) is input to the A/D converter 106, the digital filter 107 and the digital signal processing section 108, an alternative structure described in this section may be possible within the scope of the present invention. In the alternative structure, as shown in FIG. 16, a PLL circuit 511 outputs two clock signals having different frequencies, channel clock CLK-ch and sampling clock CLK-s. Sampling clock CLK-s has a frequency N times higher than that of channel clock CLK-ch (N is an integer equal to or greater than 2). Channel clock CLK-ch is input to the digital signal processing section 108, while sampling clock CLK-s is input to the A/D converter 106 and the digital filter 107. Referring to FIG. 17 which shows the principal part of the PLL circuit 511, the PLL circuit 511 includes a frequency dividing circuit 545 in addition to the frequency dividing circuit 145 of the PLL circuit 111 (FIG. 6) of embodiment 1. The frequency dividing circuit 545 has a smaller frequency-dividing ratio (i.e., outputs a clock signal having a higher frequency) as compared with the frequency dividing circuit 145. The PLL circuit 511 further includes a frequency-dividing ratio setting circuit 546 for controlling the frequency-dividing ratios of the frequency dividing circuits 145 and 545. (It should be noted that the present invention is not limited to the above structure. An alternative arrangement may be possible wherein sampling clock CLK-s is first generated, and channel clock CLK-ch is then generated by dividing the frequency of sampling clock CLK-s.)

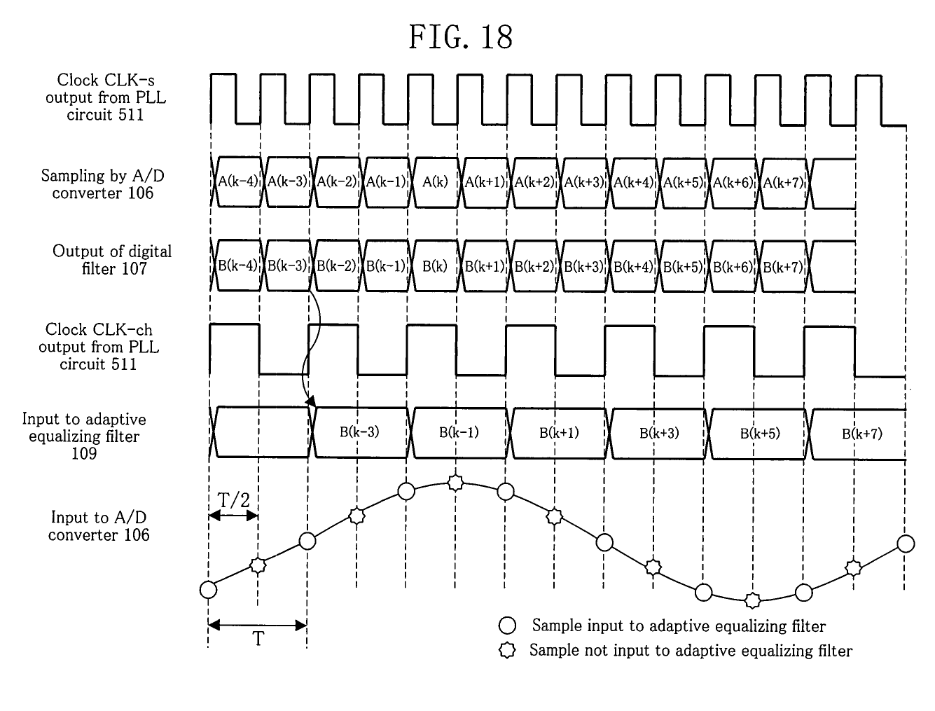

Since channel clock CLK-ch is used for controlling the timings of PR equalization, Viterbi detection, and subsequent data processing, the frequency of channel clock CLK-ch is determined according to the reading speed of recorded data. On the other hand, sampling clock CLK-s, which is used in a sampling operation by the A/D converter 106 and in pre-equalization by the digital filter 107, is subjected to equalization processing with higher resolution over the time axis as the clock period decreases (i.e., the oversampling rate increases). As a result, discrete data signal processing more resembles analog processing. Thus, for example, when the frequency-dividing ratio of the frequency dividing circuit 545 is set to a ½ of that of the frequency dividing circuit 145, sampling and pre-equalizing are performed with a period of T/2 where T is the operation period of PR equalization, or the like, as shown in FIG. 18. Therefore, data of a larger number of sampling points are input to the digital filter 107 as compared with the data input to the adaptive equalizing filter 109, and therefore, the pre-equalization described in embodiments 1-4 is performed with higher accuracy.

(Variation 2)

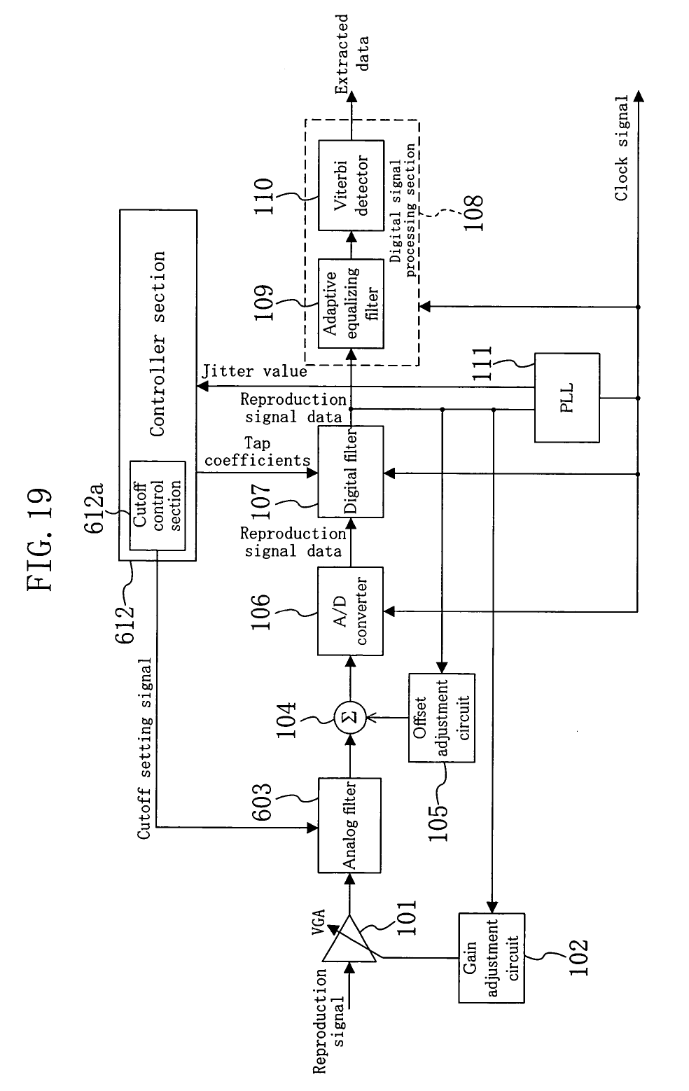

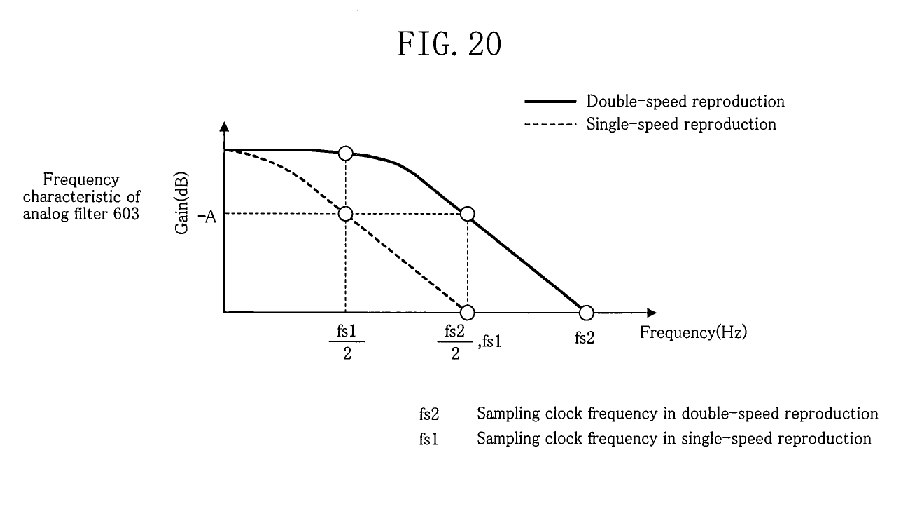

A reproduction signal processing device wherein the characteristics of an analog filter is changed for different reading speeds is now described. In this reproduction signal processing device, as shown in FIG. 19, the frequency characteristic of an analog filter 603 is controlled by a cutoff control section 612a of a controller section 612. Specifically, the frequency characteristic of the reproduction signal processing device is switched between, for example, a characteristic represented by a solid line of FIG. 20, which is employed in the case of a double-speed reproduction mode (for example, at the reading speed two times higher than that of CD (Compact Disc)), and a characteristic represented by a broken line of FIG. 20, which is employed in the case of a single-speed reproduction mode. Such a control of the frequency characteristic of the analog filter 603 can be achieved by switching resistors, capacitors, or the like, included in the analog filter 603.

In the case where an analog signal is subjected to a sampling and converted into a digital signal, an aliasing occurs with respect to a frequency which is a ½ of the sampling clock frequency. The sampling clock frequency changes in proportion to the reading speed so long as the oversampling rate is constant. Now, consider a case where in double-speed reproduction mode, the sampling clock frequency is fs2, and the gain of the analog filter 103 at a frequency of fs2/2 is −A (dB) which is sufficient for suppressing an aliasing. In such a case, when the reproduction mode is switched to single-speed reproduction mode, the frequency characteristic is changed to the characteristic represented by the broken line in FIG. 20, whereby the gain of the analog filter 103 at a frequency of fs1/2 is −A (dB) which is the same as that employed in double-speed reproduction mode. (It should be noted that the cutoff characteristic and boost characteristic of the digital filter 107 are also controlled according to the reading speed, i.e., the frequency of the clock signal at which the digital filter 107 operates, and that such a control is readily achieved by setting the tap coefficients.)

As described above, the characteristics of the analog filter 103 are changed according to the reading speed such that the frequency components equal to or higher than a ½ of the sampling clock frequency (the frequency components in a band which is not necessary for inputs to the A/D converter 106) are attenuated with a gain equal to or smaller than a predetermined gain. With such an arrangement, effects of aliasing noise caused during A/D conversion are reduced. Furthermore, appropriate pre-equalization is performed with the digital filter 107 as described in embodiment 1. As a result, reproduction of recorded data is performed with high accuracy.

The characteristics of the analog filter 603 may be changed not only according to the reading speed as described above, but also according to information indicating the type of a recording medium (e.g., CD or DVD) which is recorded in the recording medium.

(Embodiment 5)

A reproduction signal processing device wherein reproduction can be performed at various reading speeds without changing the characteristics of an analog filter is now described.

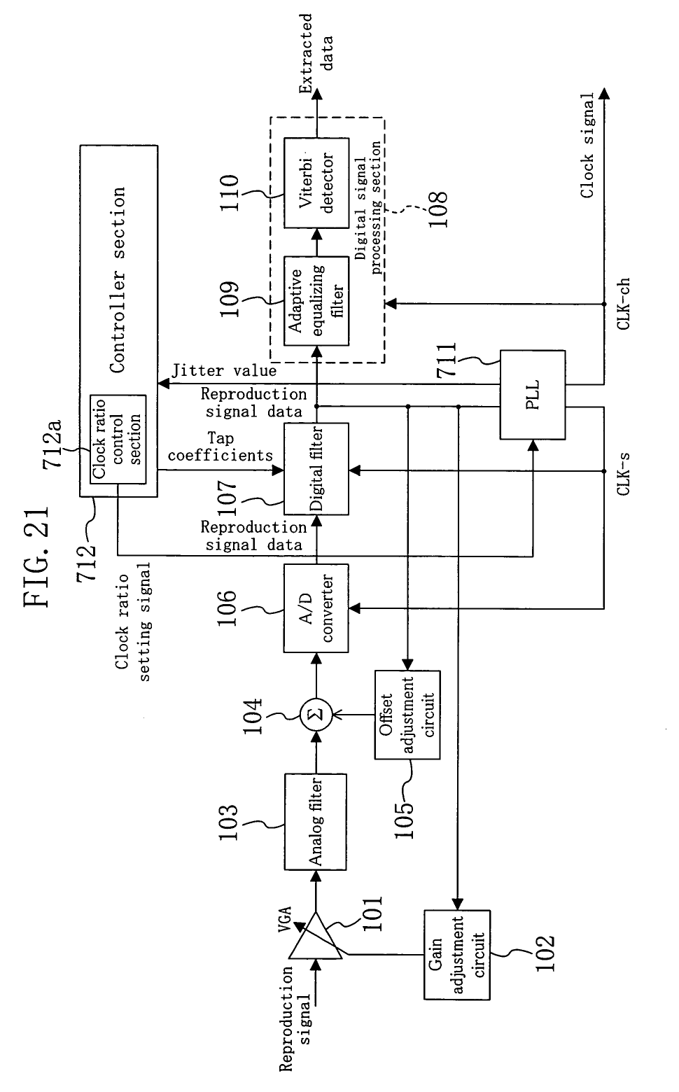

Referring to FIG. 21, the reproduction signal processing device of embodiment 5 includes a PLL circuit 711 and a controller section 712. The PLL circuit 711 outputs channel clock CLK-ch and sampling clock CLK-s as the PLL circuit 511 (FIG. 17) of Variation 1 (FIG. 16) does. The controller section 712 includes a clock ratio control section 712a.

The PLL circuit 711 has substantially the same structure as that of the PLL circuit 511, except that the frequency of channel clock CLK-ch is controlled by the clock ratio control section 712a according to the reading speed, while the frequency of the sampling clock CLK-s is kept at a constant frequency irrespective of the reading speed. (It should be herein noted that the “constant frequency” refers not to a strictly-constant frequency but to a frequency within a certain frequency band determined in consideration of a variation due to a feedback loop, or the like.)

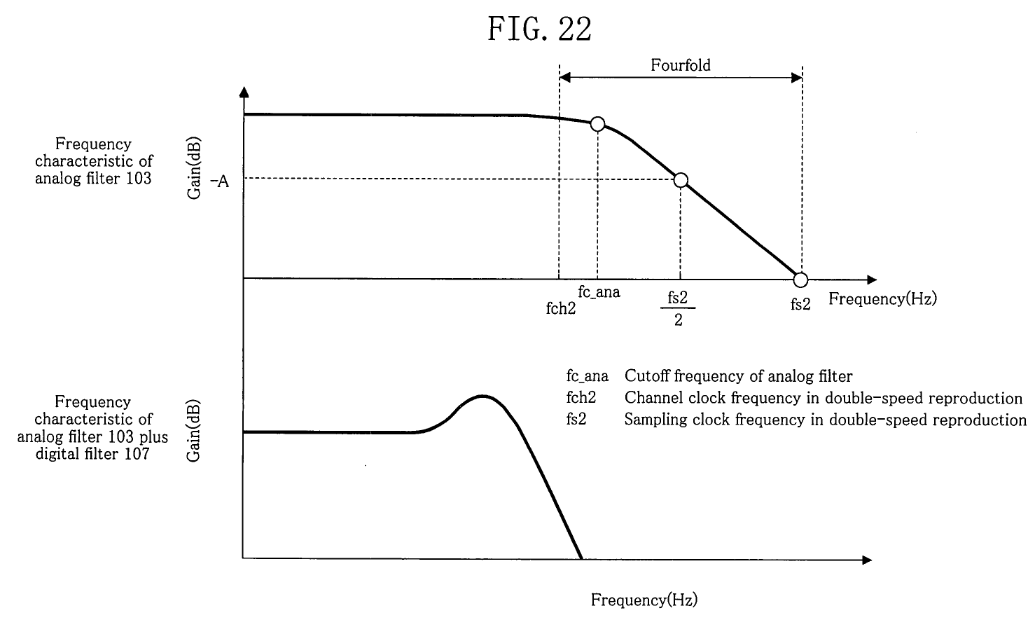

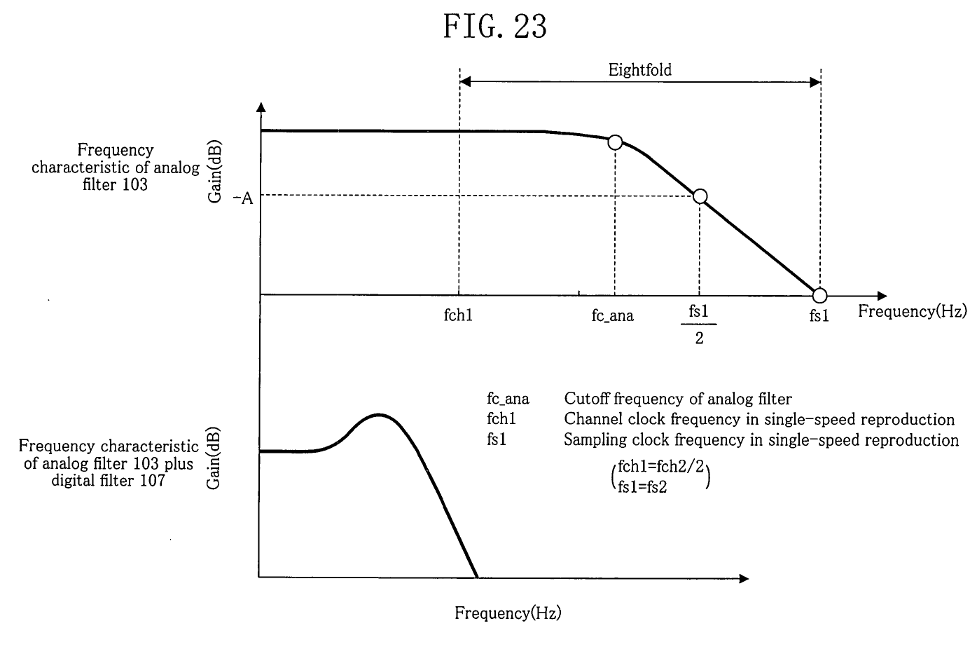

For example, if sampling clock frequency fs2 which is used for double-speed reproduction is equal to sampling clock frequency fs1 which is used for single-speed reproduction, the gain of the analog filter 103 is −A (dB) at both fs1/2 and fs2/2 as shown in FIGS. 22 and 23. Assuming that this largeness of the gain, i.e., −A (dB), is sufficient for suppressing aliasing noise, both double-speed reproduction and single-speed reproduction can be realized with the analog filter 103 (i.e., with the same filter characteristic).

On the other hand, channel clock frequency fch1 used for single-speed reproduction is a ½ of channel clock frequency fch2 used for double-speed reproduction. If the oversampling rate in the double-speed reproduction is 4 (fs2/fch2=4), the oversampling rate in the single-speed reproduction is 8 (fs1/fch1=fs2/(fch2/2)=8), which is two times higher than that in the double-speed reproduction

In this case, assuming that the number of taps required for pre-equalization in the digital filter 107 in the double-speed reproduction mode is 5, for example, the number of taps required for the same pre-equalization in the single-speed reproduction mode is 10. In view of such, the reproduction signal processing device of the present embodiment may be designed such that the circuits for 10 taps are provided in the digital filter 107. Furthermore, the tap coefficients for 10 taps (for single-speed reproduction) and the tap coefficients for 5 taps (for double-speed reproduction: tap coefficients are 0 (zero) in 5 out of 10 taps) are retained in the tap coefficient table of the controller section 712, and any of these tap coefficients may be selectively used according to the reading speed.

The optimum tap coefficients are selected from the tap coefficient table and set in the digital filter 107 as described in embodiment 1. As a result, the characteristics for achieving appropriate pre-equalization for respective reading speeds are obtained by the combination of the frequency characteristics of the analog filter 103 and the digital filter 107 as shown in FIGS. 22 and 23. Furthermore, the necessity of changing the characteristics of the analog filter 103 as described in Variation 2 is avoided, and therefore, the structure of the analog filter 103 can be simplified. Accordingly, the chip area of a semiconductor integrated circuit in which the reproduction signal processing device of the present invention is integrated is limited within a small area.

It should be noted that the structures described in the above embodiments and variations may be combined into various combinations so long as such combinations are logically possible. Specifically, for example, the structure described in embodiment 4 wherein the tap coefficients of the digital filter 107 and the adaptive equalizing filter 109 are synthesized may be combined with the structure described in embodiments 2 and 3 wherein the tap coefficients of the digital filter 107 are set according to the equalization error or the difference between input data and output data in the adaptive equalizing filter 109. Alternatively, the structure wherein oversampling is performed and the structure wherein the characteristics of the analog filter 103 are changed according to the reading speed, which have been described in Variations 1 and 2, may be combined with the above structure described in embodiments 2 and 3.

In variation 2 and embodiment 5, the reading speed is switched between single-speed mode and double-speed mode, but the present invention is not limited thereto. For example, according to the present invention, the filter coefficients of the digital filter 107 is readily set such that reproduction is appropriately performed at various reading speeds from ×1-mode to ×16-mode. In this case, the tap coefficients set in the digital filter 107 are selected according to the reading speeds from a tap coefficient table including a plurality of sets of tap coefficients which correspond to different reading speeds, which is similar to the table shown in FIG. 5, for example.

The plurality of combinations of tap coefficients may be retained in a table, or the like, so as to correspond to information recorded in a recording medium which indicates the type of the recording medium (for example, a CD or a DVD, Read Only Memory (ROM) or Random Access Memory (RAM), etc.) and selectively used according to such information.

In the above descriptions, the digital filter 107 and the adaptive equalizing filter 109 have 3 taps and 5 taps, respectively, for convenience of illustration, but the present invention is not limited thereto. For example, the number of taps in these filters may be determined according to the type of a recording medium, the reading speed, etc. Specifically, hardware (i.e., a reproduction signal processing device) is designed such that a filter has, for example, 20 taps in consideration of a sufficient margin with respect to a RAM recording medium which generally has a low S/N ratio. In the case where this reproduction signal processing device reproduces data recorded in a ROM recording medium, effective tap coefficients are set in taps to the number of taps necessary for reproduction of the data (e.g., 10 taps), and tap coefficients of 0 (zero) are set in the remaining taps.

In the above-described examples of the reproduction signal processing device of the present invention, the PRML method and Viterbi detection scheme are used, but the present invention is not limited thereto.

In the above examples, the reproduction signal processing device which reproduces data recorded in a removable disc, such as an optical disc, or the like, has been described, but the present invention is not limited thereto. For example, the present invention may be applied to a recording unit, such as a hard disk drive. Alternatively, the present invention may be applied to a reproduction apparatus for reproducing data transmitted through a transmission path, or the like.

According to the present invention, as described above, a digital filter is provided at a position between an A/D converter and an adaptive equalizing filter and between the A/D converter and a PLL circuit. Tap coefficients determined based on a jitter value of the PLL circuit, or the like, during a learning period prior to a reproduction operation are set in the digital filter to carry out pre-equalization. As a result, highly-accurate reproduction of recorded data is performed both surely and readily, and thus, the recording density is greatly increased. Furthermore, an analog filter having only a low pass function is used, whereby the structure of the analog filter is simplified. Accordingly, the chip area of a semiconductor integrated circuit in which the reproduction signal processing device of the present invention is integrated is limited within a small area.

What is claimed is:

1. A reproduction signal processing device, comprising:
an A/D converter for quantizing an input analog reproduction signal into digital reproduction signal data;
an adaptive equalizer for equalizing the reproduction signal data with a characteristic controlled according to data input to the adaptive equalizer and data output from the adaptive equalizer; and
a PLL circuit for outputting a clock signal which is in synchronization with the reproduction signal data;
an analog filter for removing noise from the reproduction signal; and
a digital filter provided between the A/D converter and the adaptive equalizer, the digital filter equalizing the reproduction signal data with a fixed characteristic,
wherein the PLL circuit outputs the clock signal based on an output of the digital filter.

2. A reproduction signal processing device according to claim 1, wherein the analog filter has a low pass characteristic.

3. A reproduction signal processing device according to claim 1, wherein the digital filter has a high band emphasis characteristic.

4. A reproduction signal processing device according to claim 3, wherein the digital filter has a low pass characteristic which allows the passage of a lower frequency component as compared with the analog filter.

5. A reproduction signal processing device according to claim 1, wherein the digital filter is a FIR filter which has a characteristic determined according to one or more tap coefficients set in the digital filter.

6. A reproduction signal processing device according to claim 1, further comprising a control section for determining the fixed characteristic of the digital filter prior to the start of reproduction signal processing.

7. A reproduction signal processing device according to claim 6, wherein:
the digital filter is a FIR filter which has a characteristic determined according to one or more tap coefficients set in the digital filter; and
the control section sets any of a plurality of tap coefficient candidate values in the digital filter, thereby determining the fixed characteristic of the digital filter.

8. A reproduction signal processing device according to claim 6, wherein the control section determines the fixed characteristic of the digital filter based on a value corresponding to a phase error in the PLL circuit.

9. A reproduction signal processing device according to claim 6, wherein the control section determines the fixed characteristic of the digital filter based on an equalization error in the adaptive equalizer.

10. A reproduction signal processing device according to claim 6, wherein the control section determines the fixed characteristic of the digital filter based on a difference between data input to the adaptive equalizer and data output from the adaptive equalizer.

11. A reproduction signal processing device according to claim 6, wherein prior to the start of reproduction signal processing, the control section synthesizes a predetermined characteristic with a characteristic converged by the operation of the adaptive equalizing filter and sets the synthesized characteristic as the fixed characteristic of the digital filter.

12. A reproduction signal processing device according to claim 11, wherein:
each of the digital filter and the adaptive equalizer includes a FIR filter which has a characteristic determined according to one or more tap coefficients; and
the control section sets, as the tap coefficient in the digital filter, a value obtained by the sum-of-products operation of the tap coefficient determined such that the digital filter has the predetermined characteristic and the tap coefficient determined such that the adaptive equalizer has the converged characteristic.

13. A reproduction signal processing device according to claim 1, wherein the PLL circuit outputs a first clock signal for driving the adaptive equalizer and a second clock signal for driving the A/D converter and the digital filter, the second clock signal having a frequency that is N times higher than that of the first clock signal where N is an integer equal to or greater than 2.

14. A reproduction signal processing device according to claim 1, wherein:
the reproduction signal processing device reads recorded data from a recording medium;
the analog filter has a low pass characteristic; and
the upper limit of a frequency component which is allowed to pass through the analog filter is changed according to the speed of reading the recorded data.

15. A reproduction signal processing device according to claim 1, wherein:
the reproduction signal processing device reads recorded data from a recording medium;
the PLL circuit outputs a first clock signal for driving the adaptive equalizer and a second clock signal for driving the A/D converter and the digital filter;
the frequency of the first clock signal is determined according to the speed of reading the recorded data; and
the frequency of the second clock signal is substantially constant irrespective of the speed of reading the recorded data.
